(19) United States
(12) Patent Application Publication
(10) Pub. No.: US 2019/0187636 A1
(43) Pub. Date: Jun. 20, 2019

(54) SMART KITCHEN SYSTEM AND METHOD

(71) Applicants: Jeffrey Fong, Calgary (CA); Peter Kwok-Chuen Leung, Toronto (CA)

(72) Inventors: Jeffrey Fong, Calgary (CA); Peter Kwok-Chuen Leung, Toronto (CA)

(21) Appl. No.: 15/844,417

(22) Filed: Dec. 15, 2017

(51) Int. Cl. G05B 13/02; H04L 12/28; H04N 5/247; G06F 3/14; G06N 3/00; G06N 99/00

(52) U.S. Cl. CPC G05B 13/0265; H04L 12/2816; H04N 5/247; H04N 5/33; G06N 3/006; G06N 99/005; H04L 2012/285; G06F 3/14

(57) ABSTRACT

A smart kitchen system includes: an imaging apparatus having a plurality of cameras and a display screen; a processing unit having a motherboard, a memory, a processor, and a power source; an audio unit having at least one microphone and at least one speaker; a lighting unit; a sensor assembly; a housing having a mounting bracket, a protective shield, and mounting hardware; a communications apparatus; and a computing device including an AI module and a server. The smart kitchen system is useful for monitoring, interacting with, and customizing the cooking of food items on a cooking appliance, while providing a user with feedback and instructions in the form of data, ingredients and other cooking information. The system also provides increased safety features configured to notify a user when dangerous conditions are present.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of wireless monitoring devices of existing art and more specifically relates to a smart kitchen system.

### RELATED ART

There are a multitude of systems available for users to remotely monitor apparatuses, such as household appliances and devices, via wireless transmission of sensor data to a user's computing device. The systems have limitations, though, in their capacity to monitor more than one type of sensor or apparatus, and to wireless exchange information in real-time with a remotely located user. They also require the apparatuses that are housing the sensor to include electronic components for analyzing the sensor data before wirelessly transmitting it. This requires extra costs in the production of the apparatuses with sensors.

There is a growing trend for consumers and producers in many fields to manufacture “smart” devices to help make lives easier. These devices are labeled “smart” devices because they may allow a user to link existing software systems and durable goods with mobile devices and other Internet-based products. As this trend continues to grow and image recognition techniques improve in both function and accuracy, the number and type of wireless sensors need to evolve as well. A suitable solution is desired.

U.S. Pat. No. 9,060,212 to Mucha Loic relates to a universal electronic monitoring device and method of use for smart cooking. The described universal electronic monitoring device and method of use for smart cooking includes a universal iKT electronic monitoring device, system and method of use, to receive data from a variety of types of sensors (e.g., measuring weight, temperature) housed within apparatuses (e.g., a kitchen appliances, utensils) that are electronically compatible with the monitoring device. The monitoring device then wirelessly transmits the sensor data to a User's mobile device (i.e., a smartphone) to be analyzed and stored. The User's mobile device also comprises software to assist in using the apparatus, such as listing recipes, or transmitting commands to the device to turn off an apparatus (e.g., oven). One iKT device is compatible for use with a multitude of electronic apparatuses, such as mixing bowls to measure the weight of cooking ingredients, spatulas and oven mats to measure food temperature, cups to measure liquid volumes, and oven controls to turn off/on or reduce the temperature.

### SUMMARY OF THE INVENTION

In view of the foregoing disadvantages inherent in the known wireless monitoring device art, the present disclosure provides a novel smart kitchen system. The general purpose of the present disclosure, which will be described subsequently in greater detail, is to provide a device and system for converting a standard kitchen into a smart-kitchen having machine learning techniques and increased safety features, without the need to purchase new cooking appliances.

A smart kitchen system is disclosed herein. The smart kitchen system may include: an imaging apparatus having a plurality of cameras and a display screen; a processing unit having a motherboard, a memory, a processor, and a power source; an audio unit having at least one microphone and at least one speaker; a lighting unit; a sensor assembly; a housing having a mounting bracket, a protective shield, and mounting hardware; a communications apparatus; and a computing device including an AI module and a server. The smart kitchen system may be useful for monitoring, interacting with, and customizing the cooking of food items on a cooking appliance, while providing a user with feedback and instructions in the form of data, ingredients and other cooking information.

According to another embodiment, a method for using a smart kitchen system is also disclosed herein. The method for using a smart kitchen system may include providing a smart kitchen system including an imaging apparatus, a processing unit, a power source, an audio unit, a lighting unit, a sensor assembly, a housing having, a communications apparatus, and a computing device including an AI module and a server, connecting the smart kitchen system to the computing device, cooking a food item on a cooking appliance, and receiving an instruction from the AI module of the computing device.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a smart kitchen system, constructed and operative according to the teachings of the present disclosure.

FIG. 1 is a perspective view of the smart kitchen system during an ‘in-use’ condition, according to an embodiment of the disclosure.

FIG. 2 is another perspective view of the smart kitchen system of FIG. 1, according to an embodiment of the present disclosure. As illustrated, the smart kitchen system may include a housing having that may be suited for mounting in a hood of a kitchen range.

FIG. 3 is a lower perspective view of the smart kitchen system of FIG. 1, according to an embodiment of the present disclosure. As illustrated, the smart kitchen system may include a housing with a lighting unit, a sensor assembly, and an imaging apparatus.

FIG. 4 is a perspective view of the smart kitchen system of FIG. 1, according to an embodiment of the present disclosure.

FIG. 5 is a flow diagram illustrating a method of using a smart kitchen system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a wireless monitoring device and more particularly to a smart kitchen system as used to provide a device and system for converting a standard kitchen into a smart-kitchen without the need to purchase new cooking appliances.

Generally, the smart kitchen system may include a device that may be useful for turning a regular kitchen into a smart kitchen without needing to purchase new smart appliances. The device can be discretely hidden away in the range/hood light compartment and can be connected to an external AI module (for example: Ski, Google Assistant, Alexa, or other smart assistant devices). Data may be sent to the external AI module by a communications apparatus built-in to the device. The data transmitted between the external AI module and the communications apparatus may include (but is not limited to): images, videos, sounds, temperature feedback, and other sensor data. This data may then be stored or used to further train AI systems. The AI module sends communications/data back to the smart kitchen system or other devices. The AI module can then connect to other smart appliances present in the kitchen or home, independently through their API interfaces.

The smart kitchen system may further include components for communicating with a mobile application or cloud devices, a motherboard, a plurality of cameras, mounting hardware including a lens and protective plate, and a network communications component. The system may further comprise a microphone with speakers and a screen/display. Further still, the system may include a plurality of sensors including a thermometer, and other local environment sensors, all of which may be configured to communicate with and assist the AI module. The system may also include devices for, and sources of, lighting the surrounding cooking areas. Power sources (including components for converting/adapting existing range electrical sources) may also be provided and may appear in the form of a plug, removable power supply, and/or power coupling adapters. Power source components of this system may include a power source adapter configured to screw into an existing light bulb socket.

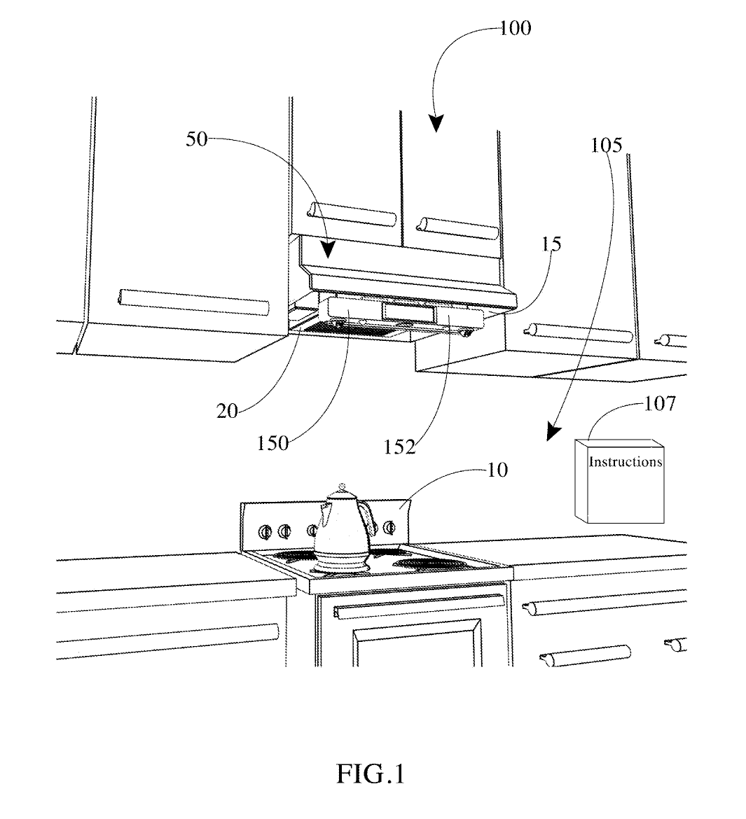

Referring now more specifically to the drawings by numerals of reference, there is shown in FIGS. 1-4, various views of a smart kitchen system 100.

FIG. 1 shows a smart kitchen system 100 during an ‘in-use’ condition 50, according to an embodiment of the present disclosure. Here, the smart kitchen system 100 may be beneficial for use by a user for converting a standard kitchen into a smart-kitchen without the need to purchase new cooking appliances. As illustrated, the smart kitchen system 100 may include a housing 150 configured for a kitchen range 20 cooking appliance 10 with a hood 15, the housing 150 having a protective shield 152. Upon reading this specification, it should be appreciated that, under appropriate circumstances, considering such issues as user preferences, design preference, structural requirements, marketing preferences, cost, available materials, technological advances, etc., other smart kitchen system 100 arrangements such as, for example, varying appliance configurations, etc., may be sufficient.

According to one embodiment, the smart kitchen system 100 may be arranged as a kit 105. In particular, the smart kitchen system 100 may further include a set of instructions 107. The instructions 107 may detail functional relationships in relation to the structure of the smart kitchen system 100 such that the smart kitchen system 100 can be used, maintained, or the like, in a preferred manner.

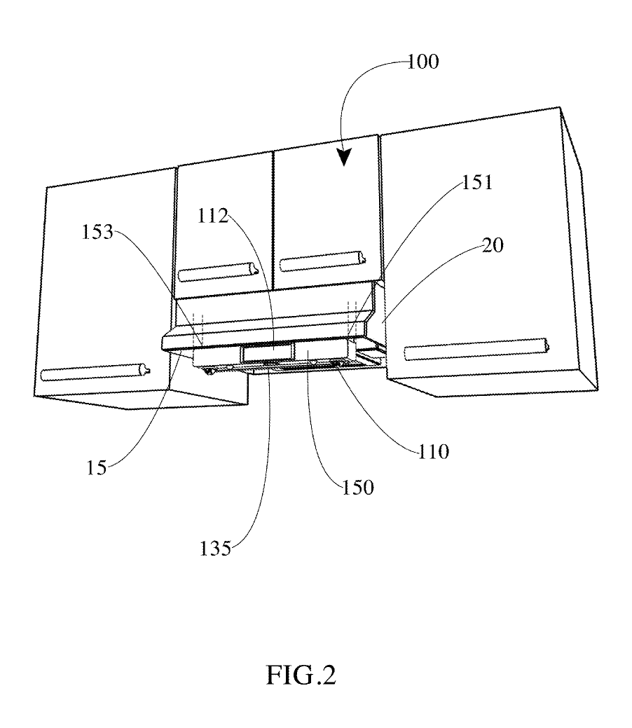

FIG. 2 shows the smart kitchen system 100 of FIG. 1, according to an embodiment of the present disclosure. As above, the smart kitchen system 100 may include an imaging apparatus 110 configured for a kitchen range 20 with a hood 15. The imaging apparatus 110 may further be mechanically coupled with a display screen 112 and an audio unit 135. The included features may be structured and arranged within a housing 150 having mounting hardware 153 and a mounting bracket 151 for installing within the hood 15 of a kitchen range 20.

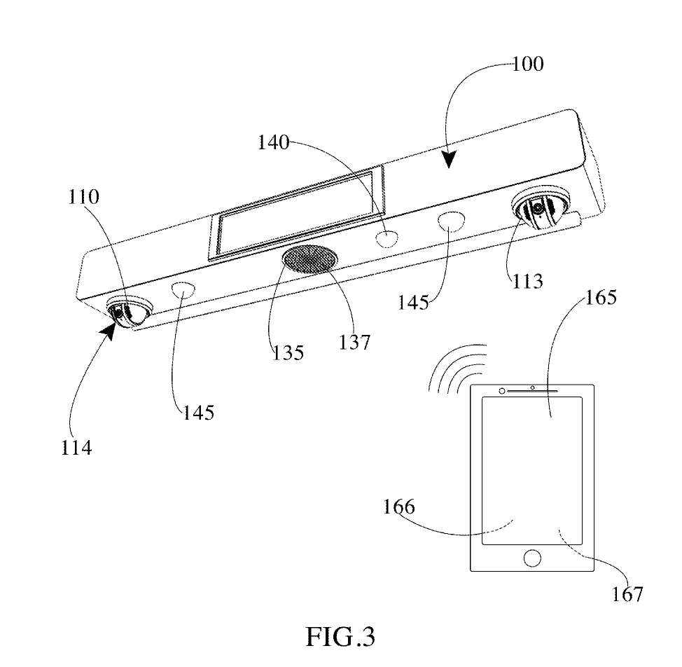

Referring now to FIG. 3 showing a lower perspective view of the smart kitchen system 100 of FIG. 1, according to an embodiment of the present disclosure. Here again, the smart kitchen system 100 may include an imaging apparatus 110 configured to monitor, regulate, and provide feedback on the surrounding cooking environment. The smart kitchen system 100 may further include a thermal camera 113 and a 3D camera array 114 configured to measure a distance and provide a 3D image of the nearby cooking areas. The system 100 may further include a lighting unit 140 and a sensor assembly 145 to respectively illuminate and monitor data of the cooking area. In addition, the smart kitchen system 100 may feature an audio unit 135 having at least one speaker 137 to provide audio feedback regarding cooking operations. The aforementioned features may further be communicably coupled with a computing device 165 including an AI module 166 and a server 167.

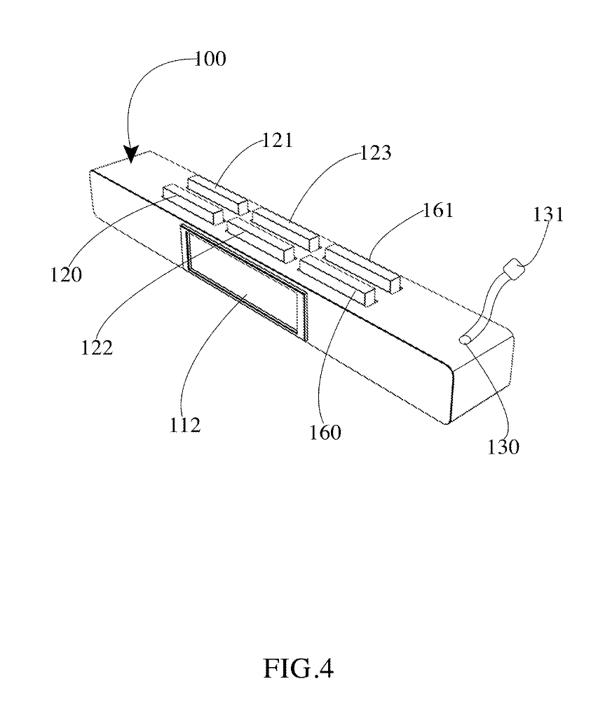

FIG. 4 is a perspective view of the smart kitchen system 100 of FIG. 1, according to an embodiment of the present disclosure. As above, the smart kitchen system 100 may include a display screen 112 configured to provide cooking instructions and feedback. The system 100 may further include a processing unit 120 having a motherboard 121, a memory 122, and a processor 123. The smart kitchen system 100 may also include a power source 130, wherein the power source 130 further comprises an adapter 131 configured for electrically coupling to an existing power outlet. Finally, the smart kitchen system 100 may also feature a communications apparatus 160 that includes a wireless communications assembly 161 configured to communicably couple with a computing device 165 (not shown; see FIG. 3).

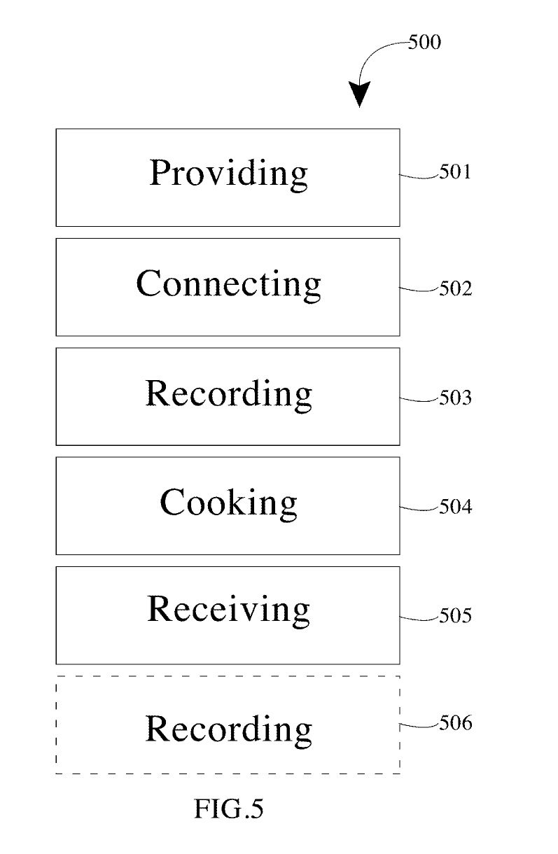

Referring now to FIG. 5 showing a flow diagram illustrating a method 500 for smart kitchen system 100, according to an embodiment of the present disclosure. In particular, the method of using 500 a smart kitchen system 100 may include one or more components or features of the smart kitchen system 100 as described above. As illustrated, the method of using 500 a smart kitchen system 100 may include the steps of: step one 501, providing a smart kitchen system 100 including an imaging apparatus 110, a processing unit 120, a power source 130, an audio unit 135, a lighting unit 140, a sensor assembly 145, a housing 150, a communications apparatus 160, and a computing device 165 including an AI module 166 and a server 167; step two 502, connecting said smart kitchen system 100 to said computing device 165; step three 503, recording sensory data; step four 504, cooking a food item on a cooking appliance 10; and step five 505, receiving feedback from said AI module 166 of said computing device 165.

It should be noted that step five 506 is an optional step and may not be implemented in all cases. Optional steps of a method of using 500 a smart kitchen system 100 are illustrated using dotted lines in FIG. 5 so as to distinguish them from the other steps of a method of using 500 a smart kitchen system 100. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for a smart kitchen system 100 are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A smart kitchen system, the system comprising:
an imaging apparatus having:
a plurality of cameras; and
a display screen;
a processing unit having:
a motherboard;
a memory; and
a processor;
a power source;
an audio unit having:
at least one microphone; and
at least one speaker;
a lighting unit;
a sensor assembly;
a housing having:
a mounting bracket;
a protective shield; and
mounting hardware;
a communications apparatus; and
a computing device including an AI module and a server;
wherein said imaging apparatus, said processing unit, said sensor assembly, and said audio unit are configured to capture data relating to a cooking appliance and communicate said data to said computing device.

2. The smart kitchen system of claim 1, wherein said plurality of cameras of said imaging apparatus includes at least one thermal camera configured to monitor a localized temperature of said cooking appliance.

3. The smart kitchen system of claim 1, wherein said plurality of cameras of said imaging apparatus includes a 3D camera array configured to measure a distance and provide a 3D image of said cooking appliance.

4. The smart kitchen system of claim 1, wherein said power source further comprises an adapter configured to be electrically coupled to said cooking appliance.

5. The smart kitchen system of claim 1, wherein said sensor assembly further comprises a thermometer configured to detect an ambient temperature about said cooking appliance.

6. The smart kitchen system of claim 1, wherein said sensor assembly further comprises a scent-detecting unit.

7. The smart kitchen system of claim 1, wherein said communications apparatus includes a wireless communications assembly configured to communicably couple with said computing device.

8. The smart kitchen system of claim 1, wherein said computing device comprises a mobile phone.

9. The smart kitchen system of claim 1, wherein said computing device comprises a desktop computer.

10. The smart kitchen system of claim 1, wherein said computing device comprises an intelligent personal assistant device.

11. The smart kitchen system of claim 1, wherein said lighting unit is configured to selectively illuminate multiple areas of said cooking appliance.

12. The smart kitchen system of claim 1, wherein said housing is configured for mounting in a hood of a kitchen range.

13. The smart kitchen system of claim 1, wherein said AI module is configured to interpret said data relating to said cooking appliance and provide an instruction to a user.

14. The smart kitchen system of claim 1, wherein said plurality of cameras of said imaging apparatus is further configured to record an image.

15. The smart kitchen system of claim 14, wherein said image is a video image.

16. The smart kitchen system of claim 14, wherein said image is a high-definition image.

17. A smart kitchen system, the system comprising:
an imaging apparatus having:
a plurality of cameras; and
a display screen;
a processing unit having:
a motherboard;
a memory; and
a processor;
a power source;
an audio unit having:
at least one microphone; and
at least one speaker;
a lighting unit;
a sensor assembly;
a housing having:
a mounting bracket;
a protective shield; and
mounting hardware;
a communications apparatus; and
a computing device including an AI module and a server;
wherein said imaging apparatus, said processing unit, said sensor assembly, and said audio unit are configured to capture data relating to a cooking appliance and communicate said data to said computing device;
wherein said plurality of cameras of said imaging apparatus includes at least one thermal camera configured to monitor a localized temperature of said cooking appliance;
wherein said plurality of cameras of said imaging apparatus includes a 3D camera array configured to measure a distance and provide a 3D image of said cooking appliance;
wherein said power source further comprises an adapter configured to be electrically coupled to said cooking appliance;
wherein said sensor assembly further comprises a thermometer configured to detect an ambient temperature about said cooking appliance;
wherein said sensor assembly further comprises a scent-detecting unit;
wherein said communications apparatus includes a wireless communications assembly configured to communicably couple with said computing device;
wherein said computing device comprises a mobile phone;
wherein said lighting unit is configured to selectively illuminate multiple areas of said cooking appliance;
wherein said housing is configured for mounting in a hood of a kitchen range;
wherein said AI module is configured to interpret said data relating to said cooking appliance and provide an instruction to a user;
wherein said plurality of cameras of said imaging apparatus is further configured to record an image;
wherein said image is a high-definition image;
wherein said smart kitchen system comprises a functional combination of said housing, said imaging apparatus, said processing unit, said power source, said audio unit, said lighting unit, said sensor assembly, said communications apparatus, and said computing device; and
wherein said smart kitchen system is configured for affixing to a hood of a kitchen range in order to monitor and communicate said data relating to said cooking appliance.

18. The smart kitchen system of claim 17, further comprising set of instructions; and
wherein the system is arranged as a kit.

19. A method for using a smart kitchen system, the method comprising the steps of:
providing a smart kitchen system including an imaging apparatus, a processing unit, a power source, an audio unit, a lighting unit, a sensor assembly, a housing having, a communications apparatus, and a computing device including an AI module and a server;
connecting said smart kitchen system to said computing device;
recording sensory data;
cooking a food item on a cooking appliance; and
receiving feedback from said AI module of said computing device.

20. The method of claim 19, further comprising the steps of:
recording an image of said food item on said cooking appliance.
